(19) United States
(12) Patent Application Publication
(10) Pub. No.: US 2009/0228151 A1
(43) Pub. Date: Sep. 10, 2009

(54) POWER DEMAND CONTROL SYSTEM FOR AIR CONDITIONING EQUIPMENT

(75) Inventors: Yu-Huan Wang, Taipei (TW); Shu-Fen Lin, Taipei (TW); Shiue-Juan Liao, Taipei (TW); Chun-Hung Huang, Taipei (TW); Chien-Yuan Chen, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: CHUNGHWA TELECOM CO., LTD., Taipei (TW)

(21) Appl. No.: 12/339,020

(22) Filed: Dec. 18, 2008

(30) Foreign Application Priority Data
Mar. 5, 2008 (TW) 097107602

(51) Int. Cl. G05B 15/00; G05D 22/00

(52) U.S. Cl. 700/278; 236/44 C

(57) ABSTRACT

A power demand control system applicable to an air conditioning equipment is provided. The power demand control system includes a server unit connected to the network system and the network station and comprising a control interface module for providing a user control interface with a operation status displaying function and a power demand adjustment function to the network workstation; and a storage module for storing an operation characteristic of the air conditioning equipment and for displaying the operation characteristic on the network station via the control interface module; and an equipment unit comprising an equipment server module connected to the network system for providing a dual information transmission between the server unit and the air conditioning equipment; and a monitoring module for monitoring and controlling an operation status of the air conditioning equipment.

### BACKGROUND OF THE INVENTION

1. Field of the Invention

This invention generally relates to a power demand control technique, and more specifically, to a power demand control system for an air conditioning equipment.

2. Description of Related Art

Air conditioning equipment are very popularly electronic equipment applied in various building, especially in large-scaled commercial places such as office buildings, factories, hotels, restaurants, supermarkets, convenience stores, wholesale stores, department stores, theaters, show rooms, etc. The current air conditioning equipment is usually integrated with load facilities, such as air conditioner heater unit, air handling unit (AHU), precooling air handler (PAH), fan coil unit (FCU), exhaust fan, water tower equipment, motor, cool water transmission equipment and/or pumping equipment.

In order to reduce electricity fee, the abovementioned large-scaled commercial places commonly will sign a contracted capacity with the power company, the contracted capacity is an agreed electricity usage capacity and is applied as a standard for calculating basic electricity payment, also the contracted capacity can be categorized into two classes, i.e. demand contracted capacity and installation contracted capacity based on user's power consumption mode. The demand contracted capacity is a contracted capacity that is the average maximum power demand in 15 minutes agreed between user and power company, and the installation contracted capacity is an agreed contracted capacity based on total installation capacity of user's electricity usage equipment.

However, after a contracted capacity is set, a problem of exceeding electricity usage arises if amount of electricity usage exceeds the contracted capacity. For instance, according to the policy of Taiwan Power Company, there are two situations: amount of electricity usage exceeds “demand contracted capacity”, namely, user's maximum power demand exceeds contracted capacity that the user applied for, if the exceeding part is less than 10% of the contracted capacity, then the exceeding part is charged at double basis rate as an additional fee, and if the exceeding part is more than 10% of the contracted capacity, then the exceeding part is charged at triple basis rate. If electricity usage exceeds “installation contracted capacity”, namely, total capacity of user's practically installed equipment exceeds contracted capacity that the user applied for, then the exceeding part of electricity usage is charged as stealing electricity.

In other words, if electricity usage falls inside scope of contracted capacity, then user gets advantage of better electricity rate, but the user must estimate a practical power demand close to contracted capacity in advance. When exceeding contracted capacity happens and an additional fee is applied, a total electricity bill may be higher than being charged based on practical electricity usage by meter reading at regular electricity rate.

On the other side, from viewpoint of the power company, if power consumed by user falls within scope of contracted capacity, then the power company is more capable of precisely predicting ideal demand of power supply, thereby further avoiding building excessive electricity generator facilities, and saving cost.

Therefore, it has become important subject of power management, i.e. how to determine a contracted capacity that is suitable to user's demand with power company without increasing electricity bill, and after the contracted capacity is signed, how to keep the maximum power demand from exceeding the signed contracted capacity.

Prior contracted capacity estimation is based on collected history records of electricity usage, and then picking out the electricity usage at highest peak or near peak to serve as basis for determining contracted capacity with power company. However, this kind of estimation does not include user's demand for preset ideal operation of air conditioning equipment as a factor, therefore the contracted capacity is possibly overestimated. For instance, prior history records of electricity usage may be power demand recorded when target temperature of usage surrounding of the air conditioning equipment is set at 24 Celsius degrees, while practically preset ideal target temperature of usage surrounding should be 26 Celsius degrees. However, in order to coordinate with target temperature control mechanism of usage surrounding, a preset ideal operation demand of air conditioning equipment should be used as referable basis for estimating contracted capacity but not the history records of electricity usage.

FIG. 1 show a how to keep the maximum power demand from exceeding the signed contracted capacity. As shown in the FIG. 1, a power demand control mainframe 1 is connected to a control center 12 via a network 11, and then the control center 12 is connected to a power monitoring unit 13 of each of operation zones A, B, C via the network 11 respectively, each of the power monitoring units 13 installed in various operation zones monitors corresponding air conditioning loads 141, 142, and 143 respectively.

In a practical operation, the power demand control mainframe 1 receives present power demands of corresponding air conditioning loads 141, 142, and 143 monitored by the power monitoring unit 13 of each of various operation zones, as well as summing up the present power demands, and then comparing total present power demands with a warning numeric value preset by user, upon reaching or exceeding the warning numeric value, the power demand control mainframe 1 transmits a warning signal to the control center 12 via the network 11, meanwhile sequentially sends out unloading signal to air conditioning load with higher priority based on unloading sequence of air conditioning load preset by the user via either the power demand control mainframe 1 or the control center 12, thereby unloading the air conditioning load. By means of unloading air conditioning load, electricity usage demand is getting lowered down before total power demand reaches or exceeds the contracted capacity, thereby avoiding exceeding contracted capacity and additional fee applicable.

The prior power demand control technique is capable of solving the problem that the electricity usage demand exceeds the contracted capacity. However, the conventional approach is to unload the load equipment directly. Take an air conditioning equipment as an example, if the air conditioning equipment is unloaded directly, then users of the air conditioning equipment have no way of using the air conditioning equipment, thereby causing a great deal of inconvenience to the users.

Hence, it is a highly urgent issue in the industry to provide a technique for estimating contracted capacity based on preset ideal operation demand of air conditioning equipment, as well as providing a more flexible mode of controlling present power demand.

### SUMMARY OF THE INVENTION

In view of the disadvantages of the prior art mentioned above, the present invention provides a power demand control system for an air conditioning equipment.

The present invention provides a power demand control system applicable to at least an air conditioning equipment, which is integrated into a network system, for a network station to monitor and control current operation power demand of the air conditioning equipment. The power demand control system includes a server unit connected to the network system and the network station, and the server unit includes a control interface module for providing a user control interface with a operation status displaying function and a power demand adjustment function to the network workstation; and a storage module for storing an operation characteristic of the air conditioning equipment and for displaying the operation characteristic on the network station via the control interface module. Further, the power demand control system includes an equipment unit connected to the air conditioning equipment, connected to the server unit via the network system, and the equipment unit includes an equipment server module connected to the network system for providing a dual information transmission between the server unit and the air conditioning equipment; and a monitoring module for monitoring and controlling an operation status of the air conditioning equipment, wherein the monitoring module monitors the air conditioning equipment to obtain the operation characteristic, the operation characteristic is transmitted to the server unit via the equipment server module, and a control demand corresponding to the operation characteristic is transmitted from the server unit to the monitoring module, so that the monitoring module control the air conditioning equipment step by step for keeping the power demand no more than a predetermined capacity.

In one embodiment of the present invention, the server unit further comprises an analyzing module for generating an electronic analysis report of electricity usage status based on the operation characteristic of the air conditioning equipment during a preset time period. Preferably, the operation characteristic includes a practical power demand of the air conditioning equipment based on the predetermined adjustment parameters.

In another embodiment of the present invention, the server unit further comprises a warning module for calculating the sum of the power demand of the air conditioning equipment and determining whether the sum of the power demand exceeds the predetermined capacity; if the sum exceeds the predetermined capacity, a warning signal is sent and the control command is sent, according to a predetermined adjustment parameter, from the server unit to the equipment unit via the network system.

Compared with the prior art, the power demand control system of the present invention transmits the operation command to the equipment unit via the network system based on the operation adjustment parameter of the air conditioning equipment corresponding to the power demand warning value. Further, in the present invention, the equipment unit controls the air conditioning equipment step by step according to the control command, so as to keep the power demand of the air conditioning equipment not more than the predetermined capacity. Moreover, in the present invention, the capacity in the contract can be calculated according to the operation characteristic value from the analyzing module based on the practical power demand corresponding to various operation adjustment values of the air conditioning equipment.

### BRIEF DESCRIPTION OF DRAWINGS

The present invention can be more fully understood by reading the following detailed description of the preferred embodiments, with reference made to the accompanying drawings, wherein:

FIG. 1 is a schematic view showing a prior power demand control system;

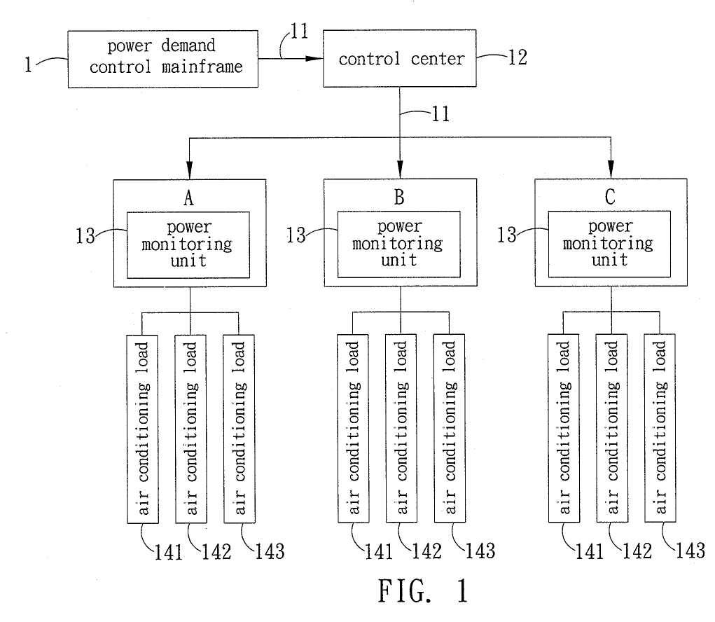

FIG. 2 is a schematic view showing the power demand control system applicable to air conditioning equipment according to the present invention;

FIG. 3A is a schematic view showing the power demand control system applicable to air conditioning equipment according to the present invention; and

FIG. 3B is a schematic view showing the power demand control system applicable to air conditioning equipment according to the present invention.

### DETAILED DESCRIPTION OF PREFERRED EMBODIMENTS

The following illustrative embodiments are provided to illustrate the disclosure of the present invention; those in the art can apparently understand these and other advantages and effects after reading the disclosure of this specification. The present invention can also be performed or applied by other different embodiments. The details of the specification may be on the basis of different points and applications, and numerous modifications and variations can be devised without departing from the spirit of the present invention.

The followings are detailed descriptions of illustrative embodiments of the power demand control system applicable to air conditioning equipment according to the present invention.

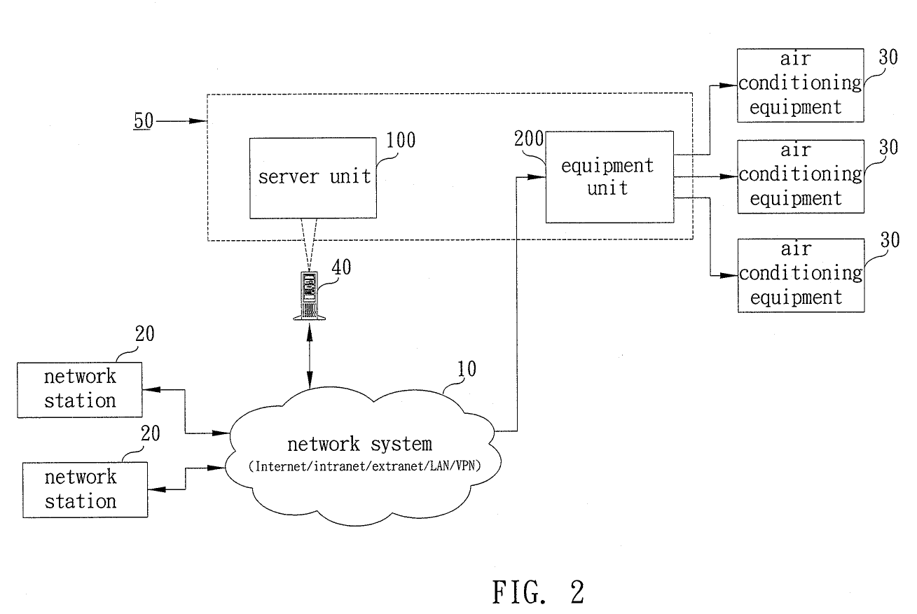

Please refer to FIG. 2 showing a power demand control system 50 applicable to air conditioning equipment of the present invention. The power demand control system 50 is connected to a network system 10, which can be Internet, intranet, extranet, wired/wireless local area network (LAN), or virtual private network (VPN). The power demand control system 50 performs networklized and instant power demand monitoring and adjustment over at least one far-end air conditioning equipment 30 via the network system 10 at network stations connected to the network system 10.

In the present embodiment, the air conditioning equipment 30 includes an air conditioner heater unit 31, an air handling unit 32, a precooling air handler 33, a fan coil unit 34, an exhaust fan 35, a water tower equipment 36, motor 37, a cool water transmission equipment 38, cool water main engines 381, pumping equipment 39, and other load equipment. The air conditioner heater unit 31 adjusts temperature of the surroundings. The air handling unit 32 adjusts humidity of the usage surroundings. The fan coil unit 34 is connected to the air conditioner heater unit 31 and/or the air handling unit 32 for discharging air, temperature and/or humidity of the air have been adjusted by the air conditioner heater unit 31 and/or air handling unit 32. The exhaust fan 35 exhausts impure air out of the surroundings of the air conditioner heater unit 31 and the air handling unit 32, thereby adjusting airborne micro particle level, carbon monoxide level and/or carbon dioxide level of the usage surroundings. The precooling air handler 33 introduces external fresh air into the surroundings, thereby adjusting airborne micro particles level, carbon monoxide level and/or carbon dioxide level of the usage surroundings, also adjusts temperature of the introduced external fresh air, and consequently controls temperature of the surroundings from being changed dramatically due to the introduced external fresh air.

It should be specifically stated herein, the air conditioning equipment 30 is not limited to abovementioned combination of air conditioner heater unit 31, air handling unit 32, precooling air handler 33, fan coil unit 34, exhaust fan 35, water tower equipment 36, motor 37, cool water transmission equipment 38, cool water main engine 381, and pumping equipment 39. The air conditioning equipment 30 can be part of the combination or another combination.

As shown in FIG. 2, the power demand control system 50 is built in a distributed architecture and comprises at least two separated units: a server unit 100 and an equipment unit 200.

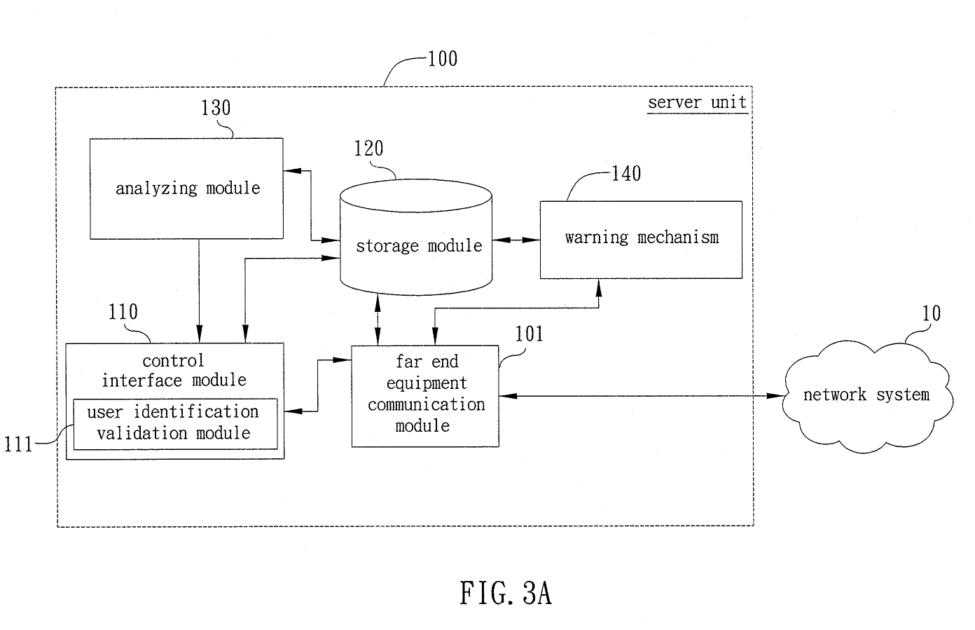

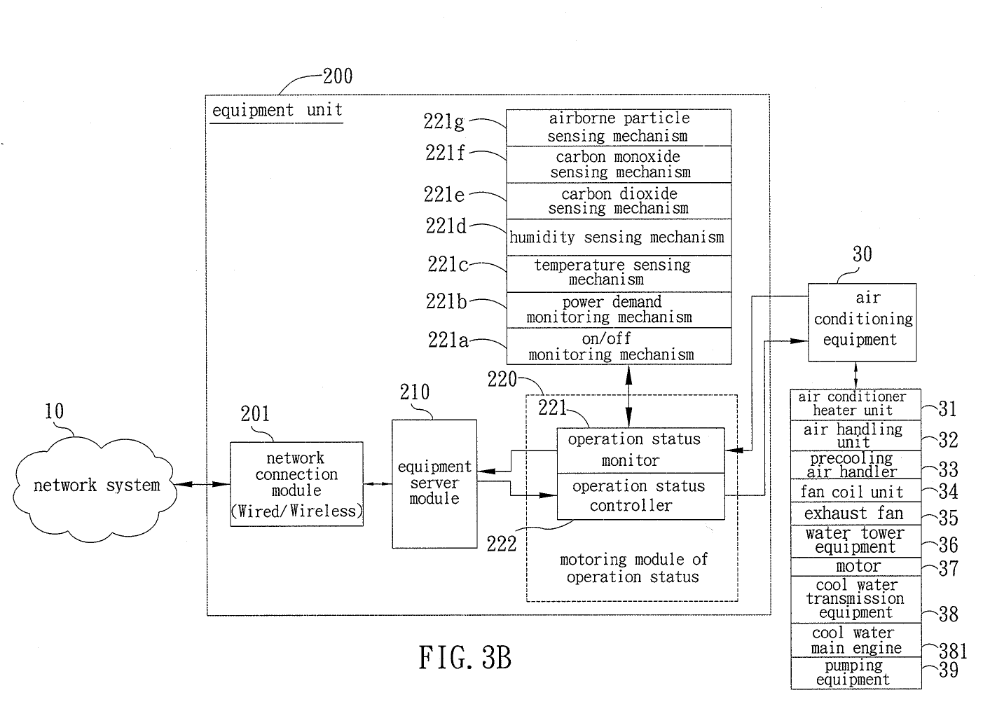

The server unit 100 can be implemented by one or more servers 40. As shown in FIG. 3A, the server unit 100 includes at least a far end equipment communication module 101, a control interface module 110, and a storage module 120. The server unit 100 selectively includes an analyzing module 130.

The equipment unit 200 is connected to the air conditioning equipment 30. As shown in FIG. 3B, the equipment unit 200 includes at least a network connection module 201, an equipment server module 210, and a monitoring module 220, and the monitoring module 220 includes an operation status monitor 221 and an operation status controller 222. In a practical application, the server unit 100 can be carried out completely through a software program that is installed inside the server 40, and the network connection module 201, the equipment server module 210, and the monitoring module 220 of the equipment unit 200 are all hardware devices.

The followings are detailed descriptions of individual character and function of each component of the server unit 100.

The far end equipment communication module 101 is for the server unit 100 to exchange information with equipment units 200 at far end via a network system 10. In other words, the operation characteristics of the controlled air conditioning equipments 30 are received from the equipment unit 200 via the network system 10. In the present embodiment, the operation characteristics are practical operation characteristics including at least practical power demand of each of the controlled air conditioning equipment 30 corresponding to various operation adjustment parameters of air conditioning equipment, the practical operation characteristics can be, e.g., present on/off status, operation surrounding values, preset operation surrounding values, adjustment parameters corresponding to preset operation surrounding values, and current situation of electricity usage. Each of the control commands is transmitted from the server unit 100 to the equipment unit 200 via the network system 10.

The operation surrounding values indicates at least one of temperature, humidity, airborne micro particle level, carbon monoxide level, and carbon dioxide level. The adjustment parameters corresponding to the preset operation surrounding values are various parameters for adjusting current operation surrounding values to the current operation surrounding value in order to control operations of the air conditioner heater unit terminal, the air handling unit terminal, the fan coil unit terminal, the exhaust fan terminal, and the precooling air handler terminal; the present electricity usage situation comprises load voltage, load current, consumed power, power demand, etc.

The control interface module 110 provides a user control interface to each network station 20 that is connected to the server 40, such as windowlization graph interface, thereby providing the network station 20 with function of displaying operation statuses of controlled equipment, command setting function, and air conditioning equipment operation schedule function. The function of displaying operation statuses is performed to display operation statuses and related information of each of the air conditioning equipment 30, including e.g., installation location, on/off status setting, rated operation characteristics of air conditioning equipment, practical operation characteristics of air conditioning equipment, power demand warning numeric values corresponding to various air conditioning equipment, preset operation adjustment parameters of air conditioning equipment corresponding to various power demand warning numeric values, etc. The function of displaying operation statuses of controlled equipment is further performed to display related specification and management information of each of the controlled air conditioning equipment 30. The related specification and management information are selected from the group consisting of brand name, model, specification, purchasing unit, purchasing date, service expiration date, installation location, management personnel, and repair/maintenance records.

The command setting function is performed to provide a set of control commands corresponding to each of the air conditioning equipment 30 for user to choose from and set, and then the equipment unit 200 transmits commands chosen by the user to each corresponding air conditioning equipment 30 via the network system 10. The control include at least one of on/off status setting, rated operation characteristics of air conditioning equipment, practical operation characteristics of air conditioning equipment, power demand warning values corresponding to various air conditioning equipment, preset operation adjustment parameters of air conditioning equipment corresponding to various power demand warning values, etc. The air conditioning equipment operation schedule function is performed to preset a period of operation time for each controlled air conditioning equipment 30 respectively, for instance, allowing the air conditioning equipment 30 to operate 7:50 AM to 17:00 PM daily. In order words, the air conditioning equipment 30 is available and activated either automatically or by the management only during the period of operation time.

In the present embodiment, the control interface module 110 optionally includes a user identification validation module 111 for system security control and verifying if a user at each network station 20 connected to the server 40 is authorized to access the user control interface provided by the control interface module 110. More specifically, the user identification validation module 111 requests the user at each network station 20 connected to the server 40 to input an identification validation information, such as, but not limited to, account number and pass code, and then determines whether the input account number and pass code identification validation information are matching with preset authorized validation information. If the user passes identification validation, then the user identification validation module 111 provides the user control interface to each of the network stations 20 connected to the server 40.

The storage module 120 stores operation characters and information related to records set by user of each of controlled air conditioning equipment 30 during practical operations, namely, the on/off status setting, the rated operation characteristics of air conditioning equipment, the practical operation characteristics of air conditioning equipment, the power demand warning values corresponding to various air conditioning equipment, the operation adjustment parameters of air conditioning equipment corresponding to various power demand warning values, etc., and further history records of the operation characters and information related to records set by users during practical operations. In addition, these history records can be displayed at the network station 20 via the control interface module 110. Furthermore, the storage module 120 also stores the related specification and management information of each of the controlled air conditioning equipment 30, and the related specification and management information include at least one of the group consisting of brand name, model, specification, purchasing unit, purchasing date, service expiration date, installation location, management personnel, and repair/maintenance records.

The analyzing module 130 is for statistically analyzing operation characteristics information of each of the controlled air conditioning equipment 30 during a preset time period by hour, day, week, or month to generate an electronic analysis report of electricity usage status. For instance, in every three months, the analyzing module 130 calculates the sum of power demands of all the controlled air conditioning equipment 30 to generate an electronic analysis report of electricity usage status, and the electronic analysis report illustrates daily usage status of each of the controlled air conditioning equipment 30, such as operation time, temperature setting, load voltage, load current, consumed power, power demand, etc., and also illustrate information related to total power demand by day, month, season (quarter), and/or year. Therefore, the management obtains the electronic analysis report at his/her network workstation 20 via the control interface module 110. The analysis report of the present invention is capable of statistically analyzing the practical operation characteristics, including practical power demand, of each controlled air conditioning equipment based on various operation adjustment parameters of air conditioning equipment, thereby providing referable bases for calculating capacity in a contract.

The followings are detailed descriptions of individual character and function of each component of the equipment unit 200.

The equipment unit 200 is connected to the network system 10 via the network connection module 201 by means of a wired network connection architecture, such as Asynchronous Digital Subscriber Line (ADSL) or Fiber to the Building (FTTB), or wireless network connection architecture, so that the equipment unit 200 exchanges information with the server unit 100 via the network system 10.

The equipment server module 210 is connected to the network connection module 201 for collecting information of each operation characteristic value monitored by the operation status monitor 221, such as on/off status and practical operation characteristics of air conditioning equipments. The practical operation characteristic values include load voltage, load current, consumed power, and power demand. Also, the collected operation characteristics information is transmitted by the network connection module 201 to the server unit 100 via the network system 10. The equipment server module 210 further transmits the control commands sent from the server unit 100 via the network system 10 to operation status controller 222 of a related air conditioning equipment 30.

The embodiment of FIG. 3B shows that the network connection module 201 is connected to only one set of equipment server module 210. However, the number of connectible equipment server module 210 depends on the number of connection port of the network connection module 201, and is not limited.

Furthermore, the server unit 100 includes a warning mechanism 140 for calculating the sum of the power demands of all air conditioning equipment 30, which are monitored by the operation status monitor 221 and collected by the equipment server module 210, and then determines if the sum of the power demands exceeds the preset power demand warning value. If the sum exceeds the predetermined capacity, a warning signal is sent and the control command is sent, according to a predetermined adjustment parameter, from the server unit 100 to the equipment unit 200 via the network system 10.

The operation status monitor 221 of the monitoring module 220 monitors operation status of each of the controlled air conditioning equipment 30 during practical operation for obtaining operation characteristics of each air conditioning equipment, and then each of the obtained operation characteristics is transmitted to the equipment server module 210 and the operation characteristics are transmitted from the equipment server module 210 to the server unit 100 via the network system 10. In a practical application, the operation status monitor 221 includes, for instance, an on/off monitoring mechanism 221a, a power demand monitoring mechanism 221b, a temperature sensing mechanism 221c, a humidity sensing mechanism 221d, a carbon dioxide sensing mechanism 221e, a carbon monoxide sensing mechanism 221f, and an airborne particle sensing mechanism 221g.

The on/off monitoring mechanism 221a monitors that air conditioning equipment power switch is on or off. The power demand monitoring mechanism 221b monitors load voltage, load current, consumed power, and power demand of each of the controlled air conditioning equipment 30. The temperature sensing mechanism 221c senses temperature of surroundings of the controlled air conditioning equipment 30. The humidity sensing mechanism 221d senses humidity of surroundings of the controlled air conditioning equipment 30. The carbon dioxide sensing mechanism 221e senses the concentration of carbon dioxide in surroundings of the controlled air conditioning equipment 30. The carbon monoxide sensing mechanism 221f senses the concentration of carbon monoxide in surroundings of the controlled air conditioning equipment 30. The airborne particle sensing mechanism 221g senses the concentration of airborne micro particles in surroundings of the controlled air conditioning equipment 30.

The operation status controller 222 of the monitoring module 220 controls each of the controlled air conditioning equipment 30 to carry out demanded operation statuses based on each control command sent from the server unit 100 via the network system 10. For instance, the air conditioning equipment 30 is controlled by the preset operation adjustment parameters of air conditioning equipment corresponding to various power demand warning values, and accordingly adjusted operation statuses include, e.g., on/off, temperature, humidity, amount of air fanned in, and amount of air exhausted out.

The followings are detailed descriptions of overall operation of the power demand control system 50 applicable to air conditioning equipment of the present invention in a practical application.

In the practical application, the network station 20 is connected to the server 40 via the network system 10, and then the server unit 100 is ready to carry out monitoring and management task over the controlled air conditioning equipment 30. For instance, the control interface module 110 receives operation instructions, such as turning on or turning off power of the controlled air conditioning equipment 30, also sets temperature, humidity, amount of air fanned in, and amount of air exhausted out thereat. The control interface module 110 responsively carries out the operation instructions and sends out corresponding control commands to the far end equipment communication module 101 for transmitting these the control commands to the equipment unit 200 via the network system 10.

When the network connection module 201 of the equipment unit 200 receives the control commands sent from the server unit 100 via the network system 10, the network connection module 201 further transmits the received control commands to the equipment server module 210, and then the equipment server module 210 decodes contents of the control commands and produces corresponding control signals, and these control signals are further transmitted to operation status controller 222 of corresponding air conditioning equipment 30, thereby enabling the operation status controller 222 to responsively control the related air conditioning equipment to carry out demanded operation statuses.

After the controlled air conditioning equipment 30 is turned on, the operation status monitor 221 continuously monitors each operation status of each controlled air conditioning equipment 30 for obtaining the operation characteristics thereof, also transmitting each operation characteristic to the equipment server module 210 and commanding the equipment server module 210 to further transmit the operation characteristic to the server unit 100 via the network system 10. For example, operation characteristics of the air conditioning equipment 30 that can be monitored include, e.g., on/off status, load voltage, load current, consumed power, power demand, temperature, humidity, carbon dioxide level in surroundings, carbon monoxide level in surroundings, airborne micro particle level in surroundings, amount of air fanned in, and amount of air exhausted out.

When the server unit 100 receives information of these the operation characteristics, the received information is immediately stored in the storage module 120; at this moment, the information of operation characteristics stored in the storage module of monitored information 120 is ready for the control interface module 110 to access, thereby comprehending current operation statuses of each of the controlled air conditioning equipment 30.

More specifically, when each power demand monitoring mechanism 221b monitors load voltage, load current, consumed power, and power demand of corresponding air conditioning equipment 30, the warning mechanism 140 of the server unit 100 calculates the sum of power demand statuses of all air conditioning equipment 30, which are monitored by the operation status monitor 221 and collected by the equipment server module 210, and then determines if the sum of power demands exceeds power demand warning value. In the present embodiment, a contracted capacity is 700 KW and a preset power demand warning numeric value is 650 KW. If the warning mechanism 140 calculates the sum of the power demand statuses of all air conditioning equipment 30 and finds the sum is equal to or greater than 650 KW, then a warning signal is sent out responsively, and then control commands of air conditioning equipment are transmitted from the server unit 100 to the equipment unit 200 via the network system 10 based on preset operation adjustment parameters of air conditioning equipment corresponding to various power demand warning values. Examples of preset operation adjustment parameters of air conditioning equipment corresponding are that temperature and/or humidity of usage surrounding of the air conditioner heater unit 31, the air handling unit 32, and/or pumping equipment 39 is raised; operation time of the precooling air handler 33, the fan coil unit 34, the exhaust fan 35, the water tower equipment 36, the motor 37 and/or the cool water transmission equipment 38 is adjusted or reduced, thereby reducing present total power demand of all the air conditioning equipment 30 without directly unloading the air conditioning equipment 30. Preferably, the operation adjustment parameters of air conditioning equipment corresponding to various power demand warning values can further include priority control of the air conditioning equipment 30. Take an office as an example, a common room is set with higher priority than a tea room; in other words, when it is determined that the sum of power demands exceeds the preset power demand warning value, temperature and/or humidity of the common room is raised first, or operation time of air conditioning equipment of the common room is adjusted or reduced first; while tea room has higher priority than office room or conference room, and so on.

In addition, during a scheduled time period by day, week, month, season (quarter), and/or year after the controlled air conditioning equipment has been activated to operate, the analyzing module 130 of the server unit 10 automatically calculates the sum of power demands of all the controlled air conditioning equipment 30, and also generates an electronic analysis report of electricity usage status, which illustrate daily electricity usage status of each of the controlled air conditioning equipment 30 as well as statistic information of total power demands by day, week, month, season (quarter) and/or year.

The management obtains the analysis report at his/her network workstation 20 via the control interface module 110, and the analysis report can be used as referable basis for capacity in future contract of the controlled air conditioning equipment 30. Preferably, the analyzing module 130 is capable of statistically analyze practical operation characteristics, including practical power demand, of each of the controlled air conditioning equipment 30 based on various operation adjustment parameters of air conditioning equipment, and the practical operation characteristics are used as referable bases for calculating the contracted capacity. More specifically, the analyzing module 130 is capable of statistically analyzing power demand of each of the air conditioning equipment 30 corresponding to various temperatures, humidities, carbon dioxide levels in the surroundings, carbon monoxide levels in the surroundings, airborne micro particle levels in the surroundings, amounts of air fanned in, and amounts of air exhausted out.

In another embodiment of the present invention, the analyzing module 130 is further capable of producing an analysis report of electricity usage status after statistically analyzing operation characteristics information of each of the controlled air conditioning equipment 30 of a preset time period, e.g., on every 5^{t}, 15^{th}, 25^{th} days of month, and further capable of setting different operation adjustment parameters of air conditioning equipment for responding to various power demand warning values that are statistically preset at various time periods. For example, if the statistic analysis report of electricity usage status shows that operation of the air conditioning equipment, on the 20^{th} of a certain month, reaches a preset power demand warning value, e.g. 650 Kw, then an approach of raising temperature and/or humidity of the common room, or first adjusting or reducing air conditioning equipment operation time of the common room is taken more seriously than another approach, which will be taken on 25^{th} of the same month if an analysis report of electricity usage status shows that air conditioning equipment operation reaches a preset power demand warning value, e.g. raising temperature setting, reducing operation time, etc., thereby warning users.

In the present embodiment, the air conditioning equipment 30 further includes more than two sets of cool water main engine 381 that are connected to the cool water transmission equipment 38, and also the operation adjustment parameters of air conditioning equipment corresponding to various power demand warning values further include keeping only a specific number of operation main engine when the air conditioning equipment operation reaches a preset power demand warning value. In the present embodiment, the main engine is the cool water main engine 381. For instance, there are two sets of cool water main engine 381 of same tonnage, and each set has 60% usage rate, namely ⅗ of compressors are turned on, when the air conditioning equipment operation reaches a preset power demand warning numeric value, then one set of the cool water main engine 381 is turned off, and the other set of cool water main engine 381 is to operate in a full load status, namely all compressors are turned on, thereby enabling the cool water transmission equipment 30 to operate normally while reducing unnecessary power demand.

In a further embodiment of the present invention, information related to records set by user and stored in the storage module 120 further includes operation adjustment parameters of air conditioning equipment for adjusting operation status of air conditioning equipment 30 corresponding to a plurality of air conditioning equipment 30 usage rates. For instance, there are two or more sets of cool water main engine 381 of same tonnage, the operation adjustment parameters of air conditioning equipment for adjusting operation status of air conditioning equipment 30 corresponding to a plurality of air conditioning equipment 30 usage rates is [when the operation status monitor 221 monitors a situation that there are two sets of cool water main engine 381, and also usage rate of each of the two sets of cool water main engine 381 of same tonnage is lower than 50%, namely less than ½ of compressors of each set of cool water main engine are turned on, then the operation status controller 222 turns off one set of cool water main engine 381, and also raises usage rate of the other set of cool water main engine 381, namely turning on remaining non-operating compressors of the other set of cool water main engine 381. When there are three sets of cool water main engine 381 of same tonnage, and usage rate of each of which is lower than 33%, namely only less than ⅓ of compressors of each set of cool water main engine 381 are turned on, then the operation status controller 222 turns off two of the three sets of cool water main engines 381, and also raises usage rate of the cool water main engines 381 that is not turned-off, namely turning on more compressors of remaining set of cool water main engine 381 that is not turned-off, when there are three sets of cool water main engine 381 of same tonnage, and usage rate of each of which is lower than 66%, namely only less than ⅔ of compressors of each set of cool water main engine 381 are turned on, then the operation status controller 222 turns off one of the three sets of cool water main engine 381, and also raises usage rate of two sets of cool water main engine 381 that are not turned-off, namely turning on more compressors of these two sets of cool water main engine 381 that are not turned-off, and so on]. Thus, the operation status monitor 221 and the operation status controller 222 control and adjust operation statuses of the air conditioning equipment 30 based on a plurality of air conditioning equipment 30 usage rates.

In summary, the power demand control system applicable to air conditioning equipment of the present invention, based on preset operation adjustment parameters of air conditioning equipment corresponding to various power demand warning numeric values, transmits air conditioning equipment control commands to the equipment unit via the network system, also commands the equipment unit to gradually control, step by step, each of the controlled air equipment to carry out demanded operation statuses based on each control command sent from the server unit via the network system to the equipment server module, and then transmitted therefrom, thereby preventing power demand of air conditioning equipment from exceeding a preset contracted capacity. In addition, the analyzing module for scheduled time operation characteristics, including practical power demands, is capable of statistically analyzing practical operation characteristics of each of the controlled air conditioning equipment based on various operation adjustment parameters of air conditioning equipment, thereby providing referable bases for calculating contracted capacity.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A power demand control system applicable to at least an air conditioning equipment, which is integrated into a network system, for a network station to monitor and control current operation power demand of the air conditioning equipment, comprising:
a server unit connected to the network system and the network station, comprising:
a control interface module for providing a user control interface with a operation status displaying function and a power demand adjustment function to the network workstation; and
a storage module for storing an operation characteristic of the air conditioning equipment and for displaying the operation characteristic on the network station via the control interface module; and
an equipment unit connected to the air conditioning equipment, connected to the server unit via the network system and comprising:
an equipment server module connected to the network system for providing a dual information transmission between the server unit and the air conditioning equipment; and
a monitoring module for monitoring and controlling an operation status of the air conditioning equipment,
wherein the monitoring module monitors the air conditioning equipment to obtain the operation characteristic, the operation characteristic is transmitted to the server unit via the equipment server module, and a control demand corresponding to the operation characteristic is transmitted from the server unit to the monitoring module, so that the monitoring module control the air conditioning equipment step by step for keeping the power demand no more than a predetermined capacity.

2. The power demand control system of claim 1, wherein the network system is one selected from the group consisting of Internet, intranet, extranet, wired network system, wireless network system, and virtual private network (VPN).

3. The power demand control system of claim 1, wherein the server unit further comprises:
a warning module for calculating the sum of the power demand of the air conditioning equipment and determining whether the sum of the power demand exceeds the predetermined capacity; if the sum exceeds the predetermined capacity, a warning signal is sent and the control command is sent, according to a predetermined adjustment parameter, from the server unit to the equipment unit via the network system.

4. The power demand control system of claim 1, wherein the server unit further comprises:
an analyzing module for generating an electronic analysis report of electricity usage status based on the operation characteristic of the air conditioning equipment during a preset time period.

5. The power demand control system of claim 4, wherein the operation characteristic includes a practical power demand of the air conditioning equipment based on the predetermined adjustment parameters.

6. The power demand control system of claim 1, wherein the operation characteristic includes at least one of a rated operation value of the air conditioning equipment, a practical operation value of the air conditioning equipment, a power demand warning value of the air conditioning equipment and an operation adjustment parameter corresponding to the power demand warning value of the air conditioning equipment.

7. The power demand control system of claim 1, wherein the server unit and the equipment unit are connected to the network system by means of Fiber To The Building (FTTB) network, ADSL or wireless network.

8. The power demand control system of claim 1, wherein the operation status displaying function is performed to display the operation status and associated information of the air conditioning equipment, and the power demand adjustment function is performed to transmit the control demand to the equipment unit via the network system according to the predetermined adjustment parameter, and wherein the adjustment parameter is an operation value of the air conditioning equipment corresponding to the power demand warning value.

9. The power demand control system of claim 1, wherein the storage module is further for storing specifications and management information related to the air conditioning equipment.

10. The power demand control system of claim 9, wherein the specifications and management information comprise at least one of brand name, model, purchasing unit, purchasing date, service expiration date, installation location, management personnel, and repair/maintenance records.

11. The power demand control system of claim 1, wherein the monitoring module comprises an operation status monitor, and the operation status monitor comprises:
an on/off monitoring mechanism for monitoring power on/off status of the air conditioning equipment;
a power demand monitoring mechanism for monitoring load voltage, load current, and consumed power of the air conditioning equipment;
a temperature sensing mechanism for sensing temperature of surroundings of the air conditioning equipment;
a humidity sensing mechanism for sensing humidity of the surroundings of the air conditioning equipment;
a carbon dioxide sensing mechanism for sensing concentration of carbon dioxide of the surroundings of the air conditioning equipment;
a carbon monoxide sensing mechanism for sensing concentration of carbon monoxide the surroundings of the air conditioning equipment; and
an airborne particle sensing mechanism for sensing concentration of airborne particles the surroundings of the air conditioning equipment.

12. The power demand control system of claim 1, wherein the control interface module further comprises an air conditioning equipment operation schedule function to preset an operation time period for the air conditioning equipment, and then the air conditioning equipment is activated to operate only during the operation time period.

13. The power demand control system of claim 1, wherein the control interface module further comprises a user identification validation module for system security management and control by verifying if a user at the network station is authorized to access a user control interface provided by the control interface module, wherein if the user passes an authorization validation, then the control interface module provides the user control interface to the network station; if the user does not pass the authorization validation, then the control interface module is prohibited from providing the user control interface to the network station.

14. The power demand control system of claim 6, wherein the practical operation characteristic of air conditioning equipment comprises load voltage, load current, consumed power, and/or power demand.

15. The power demand control system of claim 1, wherein the air conditioning equipment is one selected from the group consisting of an air conditioner heater unit, an air handling unit (AHU), a precooling air handler (PAH), a fan coil unit (FCU), an exhaust fan, a water tower equipment, a motor, a cool water transmission equipment, a cool water main engine, and a pumping equipment.

16. The power demand control system of claim 1, wherein the operation adjustment parameter of the air conditioning equipment comprises on/off, temperature, humidity, amount of air fanned in, amount of air exhausted out, and/or adjustment of operation main engine number.

17. The power demand control system of claim 1, wherein the storage module is further for storing operation adjustment parameters of the air conditioning equipment corresponding to usage rates of a plurality of air conditioning equipments; and the operation status monitor and operation status controller are for adjusting operation statuses of the air conditioning equipment based on the usage rates of the plurality of air conditioning equipments.
